(19) United States
(12) Patent Application Publication
(10) Pub. No.: US 2008/0145471 A1
(43) Pub. Date: Jun. 19, 2008

(54) Arrangement for Receiving a Casting Mold

(76) Inventor: Günter Richter, Altenkirchen (DE)

Correspondence Address: FRIEDRICH KUEFFNER, 317 MADISON AVENUE, SUITE 910, NEW YORK, NY, 10017, US

(21) Appl. No.: 11/885,809

(22) PCT Filed: Feb. 1, 2006
(86) PCT No.: PCT/EP06/50578

§ 371 Date: Sep. 6, 2007

(30) Foreign Application Priority Data
Mar. 7, 2005 (DE) 10 2005 010 396.0

(51) Int. Cl. B29C 49/56; B22D 17/26

(52) U.S. Cl. 425/541

(57) ABSTRACT

The invention relates to an arrangement for receiving a mould comprising at least two die platens (14, 16) arranged on a base frame (12), at least one of said die platens (14, 16) being displaceably arranged on the base frame (12), and the front sides (15, 17) of the die platens (14, 16) essentially facing each other. At least one locking element (38 to 44) is displaceably arranged by means of a locking mechanism in such a way that it can be displaced from an inserted position, wherein the locking element (38 to 44) does not protrude from the surface of the front side (15, 17) of the first die platen (14, 16), at least into a second withdrawn position, in which the locking element (38 to 44) protrudes into a receiving opening (54 to 60) provided in the front side (15, 17) of the opposite die platen (38 to 44).

The invention concerns an arrangement for receiving a casting mold with at least two mold mounting plates mounted on a base frame. At least one of the mold mounting plates is displaceably mounted on the base frame. The invention also concerns a blow molding machine for producing blow molded articles and a method for closing and locking a casting mold with at least two parts.

Previous blow molding machines include closing systems for closing a casting mold with at least two parts. These closing systems contain two or four tie rods for fixing the machine plates and mold mounting plates, which are mounted on a base frame, and especially to absorb the forces that arise between the mold mounting plates during the blow molding process. Closing systems of this type additionally have two or four guide tubes and at least two closing and driving cylinders for moving the mold mounting plate from a position in which the parts of the casting mold mounted on the mold mounting plate are mounted separately to a position in which these parts meet and form a closed casting mold. In addition, closing systems for blow molding machines are known which have a base frame a a mounting plate or a crosshead. Furthermore, these systems have two mold mounting plates and two or four guide rods for guiding the displacement movement of the mold mounting plates and a closing cylinder for carrying out the displacement movement of the mold mounting plates.

In addition, so-called rodless closing systems are known, which have a base frame, on which two mold mounting plates are mounted, where at least one driving cylinder is provided, which brings about a uniform displacement movement of the mold mounting plates by means of a compensating mechanism. Furthermore, a locking system is provided to fix the mold mounting plates in a suitable position, at least during the blowing process. Locking systems of this type are also known as rodless closing systems or rodless closing units. In these rodless closing units, it is advantageous for there to be relatively great freedom of movement during the removal of the cast molded part from the mold and relatively great freedom of movement during the shaping of the molded parts themselves. In closing systems with two or four tie rods, the mold size is severely limited by the tie rods. Removal of the cast molded part is also hindered by the tie rods.

However, in previously known closing units, the locking elements of the locking system often do not withstand the severe stresses that occur during the blowing operation, and the operation of the locking elements is relatively expensive and complicated. Furthermore, these locking elements in previously known rodless closing systems do not limit the freedom of movement during removal of a cast molded part as severely as the rods in other known closing systems, but the locking elements are troublesome during the mold change, since they protrude from the mold mounting plates and thus restrict the freedom of movement during a mold change. In addition, the locking elements can be easily damaged, for example, by careless handling of mold parts or by careless handling before or after the blowing operation. Due to the aforementioned compensating mechanism for uniform displacement of the mold mounting plates, only a synchronous closing movement of the mold parts is possible.

The objective of the invention is to specify a system and a method in which simple handling is possible even during a mold change and damage of the locking elements is avoided.

This objective is achieved by an arrangement for receiving a casting mold with the features of claim 1. Advantageous modifications of the invention are specified in the dependent claims.

An arrangement for receiving a casting mold with the features of claim 1 provides a simple means of achieving unrestricted freedom of movement between the mold mounting plates in the retracted position of the locking element, since the locking element does not protrude from the front face of the mold mounting plate. In addition, especially by virtue of the fact that the locking element extends into a receiving hole in the front face of the opposite mold mounting plate, reliable locking can be achieved in a simple way.

A second aspect of the invention relates to a blow molding machine for producing blow molded articles, which contains an arrangement of the invention for receiving a casting mold. In a blow molding machine of this type, a mold change can be carried out in a simple fashion. In addition, the locking element is protected from damage during the operation of the blow molding machine, since in its retracted state, it does not project into the region in which actions are carried out for preparing for the blowing operation, finishing the blowing operation, or changing the mold. Especially during the blowing operation, considerable forces are applied to the mold parts of the casting mold, which are then transmitted from the mold parts to the mold mounting plates. The locking element absorbs at least part of these forces and locks and fixes the position of the two mold mounting plates relative to each other. Preferably, the locking element absorbs the totality of the forces acting on the parts of the casting mold or the parts of the blowing mold during the molding operation, i.e., during the blowing operation. If several locking elements are provided, the forces acting on the parts of the casting mold or the parts of the blowing mold during the molding operation are preferably uniformly distributed on the locking elements. The mold mounting plates are thus prevented from moving apart by the locking elements.

A third aspect of the invention relates to a method for closing and locking a casting mold with at least two parts, in which at least one of at least two mold mounting plates mounted on a base frame is displaced in such a way that the two parts of the casting mold connected with the mold mounting plates are joined together to form a casting mold. At least one locking element is displaced by means of a locking mechanism from a retracted position, in which the locking element does not protrude from the surface of the front face of the first mold mounting plate, at least into a second, extended position, in which the mold mounting plate extends into a receiving hole provided in the front face of the opposing, second mold mounting plate.

A method of this type in accordance with the invention makes it possible to fit the parts of the casting mold together in a simple way, such that the position of the parts of the casting mold connected with the mold mounting plates is fixed by locking and fixing the position of the mold mounting plates relative to each other. This ensures that even during the molding operation or during the molding operation, the position of the parts of the casting mold relative to each other remains constant, and a shaped molded part is produced in the desired shape and size. In its retracted position, the locking element does not protrude from the surface of the front face of the mold mounting plate, so that it is also easily possible to carry out a mold change in the retracted position of the locking element, and the locking element does not restrict freedom of movement during the mold change and cannot be damaged by careless handling of the mold during the mold change.

The present invention is explained in greater detail below with reference to the preferred embodiment illustrated in the drawings, which is described on the basis of specific terminology. It should be noted, however, that the scope of the invention is not limited to this specific embodiment, since changes and other modifications to the illustrated devices and the methods and other applications of the invention than those shown here can be regarded as ordinary present or future technical knowledge of one skilled in the art. The drawings show a specific embodiment of the invention, namely:

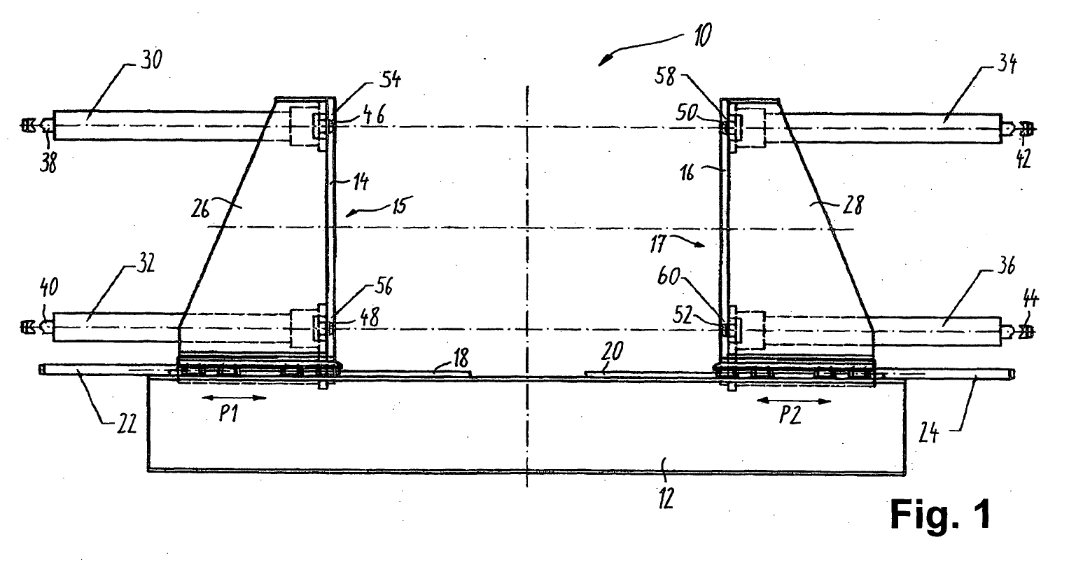

FIG. 1 shows a side view of an arrangement for receiving a two-part casting mold with locking elements completely retracted.

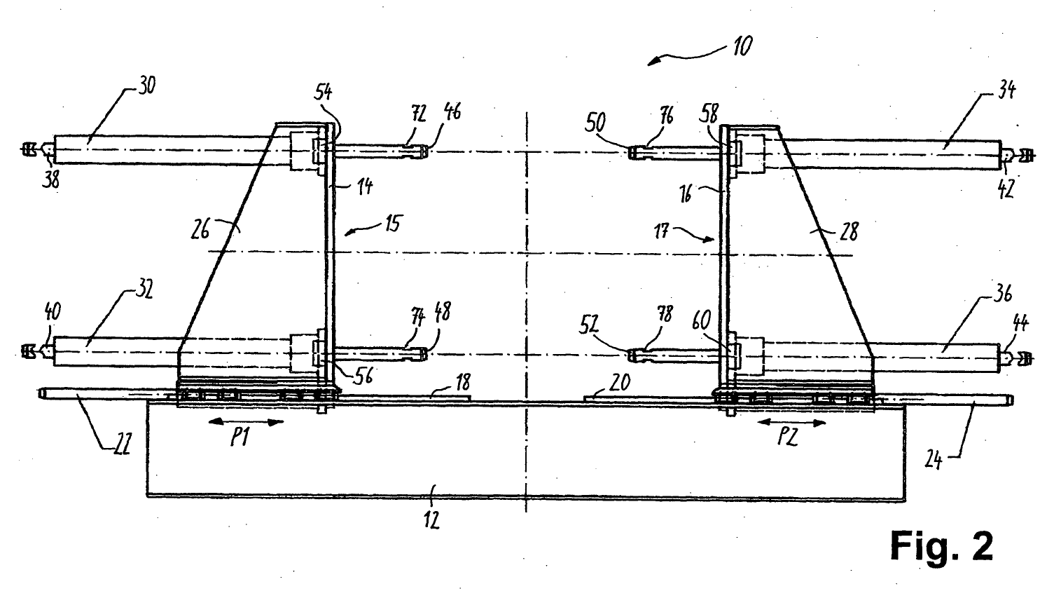

FIG. 2 shows a side view of the arrangement according to FIG. 1 with the locking elements half closed.

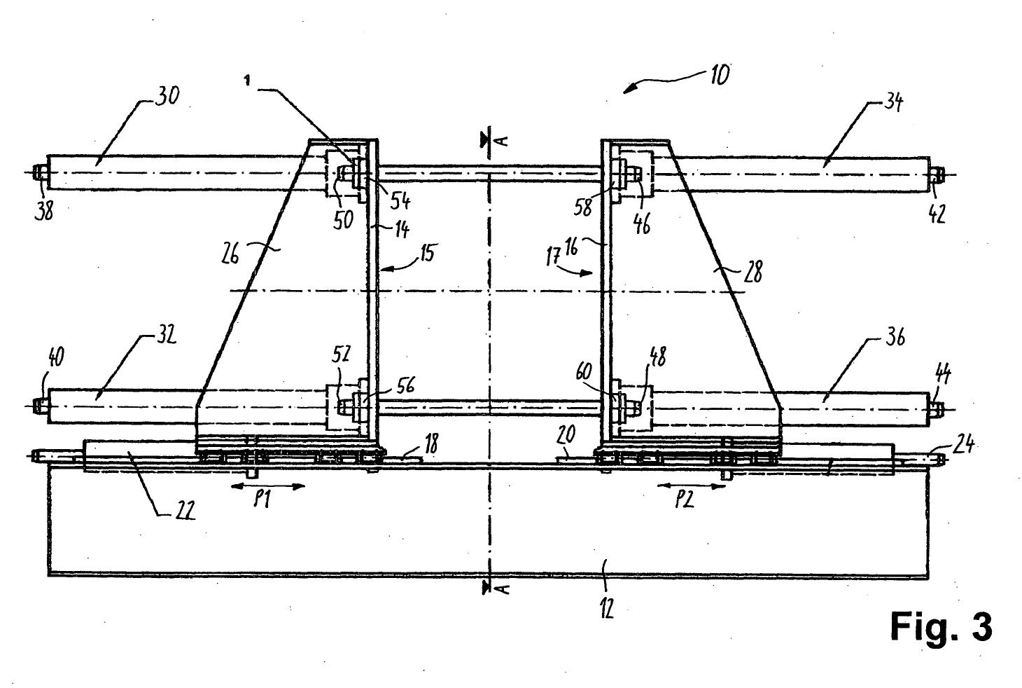

FIG. 3 shows a side view of the arrangement according to FIGS. 1 and 2, in which the locking elements are shown in a fully closed position.

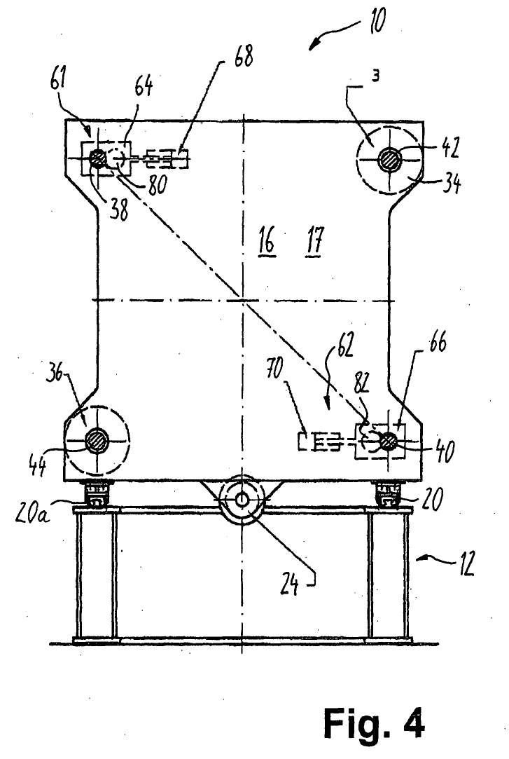

FIG. 4 shows a view of the arrangement according to FIGS. 1 to 3 along sectional line A-A.

FIG. 1 shows a side view of an arrangement 10 for receiving the parts of a two-part casting mold, which is used in a blow molding machine to produce blow molded plastic parts. This arrangement 10 has no tie rods, which hinder handling during the opening and closing of the mold for removing the blow molded part or during a mold change. The arrangement 10 has a base frame 12. Mold mounting plates 14, 16, each of which is inserted in two guide rails 18, 20, are mounted on the base frame 12. The movement of the mold mounting plates 14, 16 is guided by these guide rails in such a way that the essentially parallel front faces 15, 17 of the mold mounting plates 14, 16 can be displaced in the direction of the arrows P1 and P2, such that the front faces 15, 17 of the mold mounting plates 14, 16 are aligned approximately parallel to each other during the displacement operation and after the displacement operation.

The mold mounting plates 14, 16 have holes into which fastening elements can be inserted, by which at least one mold part of a blowing mold with at least two mold parts can be connected with one of the mold support plates 14, 16 and can be aligned in such a way that it is suitably positioned. The arrangement 10 has two hydraulic cylinders 22, 24 for driving the mold mounting plates 14, 16 in the direction of the arrows P1 and P2 in order to displace them. The hydraulic cylinders 22, 24 are connected by lines with a hydraulic system of the blow molding machine and are controlled by means of valves with a control unit, which is not shown in the drawing. Each mold mounting plate 14, 16 has two reinforcing elements 26, 28, which are arranged on the rear side of the mold mounting plates 14, 16. Only one each of the reinforcing elements 26, 28 is shown in the drawing.

Locking elements 38, 40, 42, 44 are arranged on the rear side of the mold mounting plates 14, 16. Each locking element is guided and supported in a guide piston 30, 32, 34, 36. In the drawing in FIG. 1, the locking elements 38 to 44 are shown in a fully retracted position, in which the front ends 46 to 52 of the respective locking elements 38 to 44 do not protrude from the surface of the front faces 15, 17 of the mold mounting plates 14, 16. The locking elements 38 to 44 protrude to the rear from the guide pistons 30 to 36 by at least their extensible length.

For reasons of space, the ends of the locking elements 38 to 44 extending to the rear from the guide pistons 30 to 36 are shown broken and shortened. A receiving hole 54 to 60, which has a shape that is complementary to the cross section of the locking element 38 to 44, is provided opposite each of the locking elements 38 to 44 in the opposite mold mounting plate 14, 16. The front part of the locking element 38 to 44 can be inserted in this receiving hole 54 to 60 and thus fits into the opposite mold mounting plate 14, 16.

The locking elements 38 to 44 that fit into the holes 54 to 60 are then locked by means of a locking device and are thus fixed at least in one direction of movement along the given locking element 38 to 44. The locking of the locking elements 38 to 44 will be explained in greater detail below in connection with FIG. 4. Each locking element 38 to 44 is likewise retracted and extended, i.e., displaced, by means of a hydraulic cylinder (not shown).

In the arrangement shown in FIG. 1, there are four locking elements 38 to 44 all together, two of which are connected with the rear side of each mold mounting plate 14, 16. The mold mounting plates 14, 16 have an essentially rectangular front face 15, 17, with the locking elements 38 to 44 being arranged diagonally opposite each other at the upper and lower vertices of the rectangle. Receiving holes 54 to 60 are provided in the two diagonally opposite corners of each mold mounting plate 14, 16 for receiving the front ends 46 to 52 of the respective oppositely arranged locking elements 38 to 44. In addition, the mold mounting plates 14, 16 are identically constructed and can thus be interchanged.

Alternatively, the locking elements can be arranged on the rear side of one of the mold mounting plates 14, 16, in which case receiving holes 54 to 60 are provided in the opposite plate 14, 16 for each of these locking elements 38 to 44. In other embodiments, the number of locking elements 38 to 44 is not fixed at four, but rather the number can be established on the basis of the size of the mold, the forces arising during the blowing operation, and the dimensioning of the locking elements 38 to 44. Instead of hydraulic cylinders 22, 24, it is also possible to provide other hydraulic, pneumatic, and electric drives both for displacing the mold mounting plates 14, 16 on the base frame 12 and for moving the locking elements 38 to 44.

In addition, the locking elements 38 to 44 coupled with a mold mounting plate 14, 16 can be displaced together in the same way by means of a common drive. Furthermore, one of the mold mounting plates 14, 16 can be rigidly connected with the base frame 12, in which case the movement for opening and closing the casting mold is carried out by the other mold mounting plate 14, 16. The movements of the mold mounting plates 14, 16 can also be coupled by means of a compensating mechanism in such a way that they execute a uniform displacement movement in the direction of the arrows P1 and P2, so that a synchronous movement for opening and closing is produced. However, two separately controlled drives for displacing the mold mounting plates 14, 16 offer the advantage that an asynchronous closing movement of the mold mounting plates 14, 16 is possible, which is advantageous especially in the production of molded parts and articles with complicated geometries.

To close the two-part casting mold, at least one of the mold mounting plates 14, 16 is thus displaced towards the other mold mounting plate 14, 16 in the direction of arrow P1 or in the direction of arrow P2 until the casting mold is closed. The locking elements 38 to 44 are then extended until their front ends 46 to 52 fit into the respective opposite receiving holes 54 to 60. In addition, locking devices are provided, which fit into a transverse groove 72 to 78 of the inserted locking element 38 to 44 and lock the locking element 38 to 44 with the respective mold mounting plate 14, 16. Movement of the locking elements 38 to 44 out of this locked position is then no longer possible.

The position of the locking elements 38 to 44 is also fixed on the drive side. This can be accomplished, for example, by a projection provided on the drive-side end. This projection touches the front end of the guide piston 30 to 36 in the extended state of the respective locking element 38 to 44. A stop of this type can also be designed to be variable, so that the stroke of the locking elements 38 to 44 can also be varied in a simple way, and the arrangement can thus be adapted to different mold sizes in a simple way. Alternatively, a stroke limiter of the locking elements 38 to 44 can be limited by means of the adjustable stroke of the respective drive, whose position is fixed by a connection to the mold mounting plate 14, 16, so that the position of the locking element 38 to 44 relative to this mold mounting plate 14, 16 is fixed via the drive.

The purpose of locking each of the locking elements 38 to 44 with both mold mounting plates 14, 16 is to absorb the forces acting on the mold mounting plates 14, 16 towards the outside during the blow molding process and to prevent the mold mounting plates 14, 16 from moving apart during the blow molding operation. To this end, the locking elements 38 to 44 are arranged horizontally and vertically offset from each other around the casting mold (not shown). The provision of several locking elements 38 to 44 around the casting mold effectively prevents joining of the mold mounting plates 14, 16 during the molding operation.

Alternatively, the same locking devices for locking the locking elements 38 to 44 can be provided on the drive side as on the opposite side.

FIG. 2 shows the arrangement 10 according to FIG. 1. The same elements have the same reference numbers. In the drawing shown in FIG. 2, the locking elements 38 to 44 are extended approximately halfway, so that a portion of the locking elements 38 to 44 projects from the front faces 15, 17 of the mold mounting plates 14, 16. Furthermore, the mold mounting plates 14, 16 themselves are moved apart, as is already shown in FIG. 1. In this position, a finished blow molded part can be removed from the opened mold, and a new preform can be placed into the mold. The locking elements 38 to 44 protruding from the surface of the front face of the mold mounting plates 14, 16 correspond approximately to the mold height of the casting mold, so that the removal of the finished blow molded part is not hindered by the locking elements 38 to 44.

FIG. 3 shows the arrangement 10 according to FIGS. 1 and 2 with the locking elements 38 to 44 closed, where the mold mounting plates have been moved into a casting position, in which the two parts of the casting mold connected with the mold mounting plates 14, 16 meet in such a way that they form a closed casting mold. In the position shown in FIG. 3, the locking elements 38 to 44 are extended so far that they enter the receiving hole 54 to 60 provided in the front face 15, 17 of the opposite mold mounting plate 14, 16 and are locked there by means of the locking devices.

FIG. 4 shows a drawing of the arrangement 10 along sectional line A-A in FIG. 3. The locking elements 38 to 44 extend into the opposite receiving holes 54 to 60 and are mechanically locked by means of locking mechanisms 61, 62. Each of the locking mechanisms 61, 62 contains a metal plate 64, 66, whose movement is guided by at least one guide rail (not shown). In addition, each of the locking systems 61, 62 contains a drive 68, 70, which is a hydraulic drive in the present embodiment. The metal plate 64, 66 can be moved horizontally back and forth by the drive 68, 70. The metal plate 64 has a relatively large round opening 80, 82, which narrows stepwise towards one side.

To insert the locking element 38 to 44 into the receiving hole 54 to 60, the metal plate 64, 66 is displaced by the drive 68, 70 in such a way that the large round opening 80, 82 coincides with the receiving hole 54 to 60 in the front face of the mold mounting plate 14, 16, and the locking element 38 to 44 is passed through the mold mounting plate 14, 16 and through the metal plate 64, 66 of the locking mechanism 61, 62. After the locking element 38 to 44 extends into the receiving hole 54 to 60, and the groove 72 to 78 is positioned in the opening 80, 82 of the metal plate 64, 66, the drive 68, 70 is operated in such a way that the metal plate 64, 66 is displaced by the drive, which causes the front end 46 to 52 of the respective locking element 38 to 44 to engage, which front end 46 to 52 is provided with a transverse groove 72 to 78 in both its upper surface and lower surface, so that the respective locking element 38 to 44 at least can no longer be pulled out of the receiving hole. The locking elements 38 to 44 are preferably round sections produced from a suitable steel. As an alternative to the transverse grooves 72 to 78 on opposite sides of the locking element 38 to 44, a circumferential transverse groove can be provided.

The invention is not limited to the locking elements 38 to 44 illustrated in FIG. 4, but rather it is possible to use any suitable locking mechanism 61, 62 which locks the locking element 38 to 44 with the respective opposite mold mounting plate 14, 16 and prevents the locking element 38 to 44 from being pulled out of the receiving hole 54 to 60. Alternatively, similar locking mechanisms 61, 62 can be provided on the drive side of the locking elements 38 to 44 to prevent the locking elements 38 to 44 from being pulled out there as well. Furthermore, to lock the locking elements 38 to 44, alternative locking devices can be provided, which preferably engage the locking element 38 to 44 with positive locking. Preferably, a snap-in locking connection is produced between the locking elements 38 to 44 and at least one of the mold mounting plates 14, 16. Alternatively or additionally, well-known clamping joints can also be provided for fixing the locking elements 38 to 44.

With an arrangement 10 of the invention shown in the drawings, the locking elements 38 to 44 can be retracted at least to the point that they are flush with the front faces 15, 17 of the mold supporting plates 14, 16, so that they no longer interfere with a mold change. The entire locking mechanism is arranged behind the mold mounting plates 14, 16, so that the size of the locking mechanisms 61, 62 is not limited. This makes it possible to provide robust locking mechanisms that are not susceptible to problems and guarantee a high level of operating reliability.

The term “casting mold” used in this application also includes blowing molds that are used especially in a blow molding process.

Although a preferred embodiment is shown in the drawings and discussed in detail in the preceding description, it is intended purely as an example and should not be considered to limit the invention. It is expressly noted that only the preferred embodiment is illustrated and described, and all changes and modifications that fall within the present and future scope of the invention are to be protected

### LIST OF REFERENCE NUMBERS

10 arrangement
12 base frame
14, 16 mold mounting plates
15, 17 front faces of 14, 16
18, 20 guide rail
22, 24 hydraulic cylinder
26, 28 reinforcing elements
30 to 34 guide piston
38 to 44 locking element
46 to 52 front end of a locking element
54 to 60 receiving hole
61, 62 locking mechanism
64, 66 metal plate
68, 70 drive
72 to 78 groove
80, 82 opening
P1, P2 directional arrows
A-A sectional plane

1. An arrangement for receiving a casting mold,
with at least two mold mounting plates (14, 16) mounted on a base frame (12), with at least one of the mold mounting plates (14, 16) being displaceably mounted on the base frame (12),
where the front faces (15, 17) of the mold mounting plates (14, 16) are arranged essentially facing each other,
with at least one locking element (38 to 44) that is mounted in a way that allows it to be displaced by a locking drive in such a way that it can be displaced from a retracted position, in which the locking element (38 to 44) does not protrude from the surface of the front face (15, 17) of the first mold mounting plate (14, 16), at least into a second, extended position, in which the locking element (38 to 44) extends into a receiving hole (54 to 60) provided in the front face (15, 17) of the opposing mold mounting plate (14, 16),
wherein the arrangement is designed as a blow molding machine for producing blow molded articles,
where both mold mounting plates (14, 16) are displaceably mounted on the base frame (12),
where a pneumatic cylinder is provided as the locking drive, and
where a hydraulic cylinder (22, 24) is provided for driving the mold mounting plates (14, 16).

2. An arrangement in accordance with claim 2, wherein locking devices (64, 66) are provided, which in the locked state engage the locking element (38 to 44) with positive locking and lock the locking element (38 to 44), which extends into the receiving hole (54 to 60).

3. An arrangement in accordance with claim 2, wherein operating means (68, 70) are provided to engage and/or disengage the locking devices (64, 66), and that these operating means (68, 70) preferably comprise a pneumatic, hydraulic, or electric drive.

4. An arrangement in accordance with claim 1, wherein a device (30 to 36) for guiding and/or operating the locking element (38 to 44) does not protrude from the surface of the front face (15, 17) of the mold mounting plate (14, 16), at least in the retracted state of the locking element (38 to 44).

5. An arrangement in accordance with claim 1, wherein each mold part of a casting mold with at least two parts can be connected with the front face of one of the mold mounting plates (14, 16), where holes for fastening means are preferably provided in the surfaces of the front faces (15, 17) of the mold mounting plates (14, 16).

6. An arrangement in accordance with claim 1, wherein at least two locking elements (38 to 44) are provided, each of which is mounted in a way that allows it to be displaced by a locking drive (30 to 38) in such a way that the locking elements (38 to 44) can each be moved from the retracted position at least into the extended position.

7. An arrangement in accordance with claim 6, wherein at least one locking element (38 to 44) is connected with each mold mounting plate (14, 16), and that, in its extended position, the locking element (38 to 44) fits into the receiving hole (54 to 60) provided for each locking element (38 to 44) in the surface of the opposite mold mounting plate (14, 16).

8. An arrangement in accordance with claim 6, wherein the front faces (15, 17) of the mold mounting plates (14, 16) have an essentially rectangular shape, and that the locking elements (38 to 44) are arranged essentially diagonally opposite each other.

9. An arrangement in accordance with claim 6, wherein there are at least four locking elements (38 to 44), with two locking elements (38 to 44) each being provided in two essentially diagonally opposite regions of the front face (15, 17) of each mold mounting plate (14, 16), such that the diagonals are preferably arranged essentially orthogonally to each other.

10. An arrangement in accordance with claim 1, wherein several locking elements (38 to 44) are provided, which are arranged more or less uniformly around a mold supporting surface of the mold mounting plates (14, 16).

11. An arrangement in accordance with claim 1, wherein a guide element (30 to 36) is provided, which guides the movement of the locking element (38 to 44) at least between the retracted position and the extended position.

12. An arrangement in accordance with claim 1, wherein a compensating mechanism is provided for uniform displacement of the mold mounting plates (14, 16), or where each mold mounting plate (14, 16) is provided with a hydraulic cylinder (22, 24) for displacing it.

13. An arrangement in accordance with claim 1, wherein the arrangement (10) is used to hold a blowing mold that comprises at least two parts.

14. An arrangement in accordance with claim 1, wherein the base frame (12) has guide rails (18, 20) for guiding the movements of the mold mounting plate (14, 16).

15. A method for closing and locking a casting mold with at least two parts,
in which at least one of at least two mold mounting plates (16, 18) mounted on a base frame (12) is displaced in such a way that the two parts of the casting mold connected with the mold mounting plates (14, 16) are joined together to form a casting mold, and
in which at least one locking element (38 to 44) is displaced from a retracted position, in which the locking element (38 to 44) does not protrude from the surface of the front face (15, 17) of the first mold mounting plate (16, 18), at least into a second, extended position, in which the locking element (38 to 44) extends into a receiving hole (54 to 60) provided in the front face (15, 17) of the opposing mold mounting plate (16, 18),
wherein the method is used to produce blow molded articles,
where both mold mounting plates (14, 16) are displaceably mounted on the base frame (12),
where a pneumatic cylinder is used as the locking drive, and
where a hydraulic cylinder (22, 24) is used to drive the mold mounting plates (14, 16).

16. A method in accordance with claim 15, wherein when the parts of the casting mold are joined together, they form a complete casting mold, such that the casting mold is closed when the parts are brought together.
